(19) United States
(12) Patent Application Publication
(10) Pub. No.: US 2023/0193011 A1
(43) Pub. Date: Jun. 22, 2023

(54) COLOR CHANGING POLYMERIC RESIN COMPOSITIONS

(71) Applicant: ECOLAB USA INC., Saint Paul, MN (US)

(72) Inventors: Ashish Dhawan, Saint Paul, MN (US); Carter M. Silvernail, Saint Paul, MN (US)

(21) Appl. No.: 18/067,942

(22) Filed: Dec. 19, 2022

Related U.S. Application Data
(60) Provisional application No. 63/265,841, filed on Dec. 22, 2021.

(51) Int. Cl. C08L 25/06; C08K 5/23

(52) U.S. Cl. CPC C08L 25/06; C08K 5/235

(57) ABSTRACT

The disclosure relates to color changing resin compositions for various applications. In particular, the color changing resin compositions are pH sensitive and indicate changes in pH that can reflect sufficient concentrations of sanitizing, disinfecting or other cleaning compositions in various applications of use. Kits for use of the color changing resin compositions, methods of synthesizing color changing resin compositions, and methods of using the same are also disclosed.

### CROSS-REFERENCE TO RELATED APPLICATION

This application claims priority under 35 U.S.C. § 119 to Provisional Application U.S. Ser. No. 63,265,841, filed on Dec. 22, 2021, which is herein incorporated by reference in its entirety including without limitation, the specification, claims, and abstract, as well as any figures, tables, or examples thereof.

### TECHNICAL FIELD

The disclosure relates to color changing resin compositions for various applications, kits for use of the compositions, methods of use, and methods of synthesis thereof. In particular, the color changing resin compositions are pH sensitive and indicate changes in pH to reflect sufficient concentrations of sanitizing, disinfecting or other cleaning compositions.

### BACKGROUND OF THE INVENTION

In the use of various cleaning and sanitizing compositions it is important that the compositions are used at a sufficient concentration for effective sanitizing, disinfecting, and/or cleaning efficacy. Various mechanisms have been employed to assess the concentration of these types of compositions including measuring for the concentration of the active species. For example, in chlorine-based or quaternary ammonium-based compositions, the amount of chlorine or quaternary ammonium compound is often measured to assess whether the composition has a sufficient concentration for the particular cleaning application. However, traditional mechanisms for measuring active concentrations of a composition have numerous drawbacks, such as expensive test equipment, inconvenience for the user to analyze, interpret, and apply results to determine whether the active species concentration indicates a sufficient concentration for the particular application, and often a lack of real-time results. Accordingly, there is a need for improved methods and mechanisms of assessing the concentration of a cleaning composition.

It is an objective of the present disclosure to synthesize color changing resin compositions.

It is an objective of the present disclosure to provide methods and mechanisms for assessing the concentration of a cleaning composition containing the color changing resin compositions.

Still a further object of the present disclosure is to provide a method and mechanism that provides concentration information in real-time, at a glance, without the need for analysis and interpretation.

Other objects, advantages and features of the present invention will become apparent from the following specification taken in conjunction with the accompanying figures.

### BRIEF SUMMARY

An advantage of the color changing resin compositions disclosed herein is that they provide a reusable, real-time color changing indicator for use in multiple cleaning compositions. Another advantage of the color changing resin compositions is that they provide a simple mechanism for determining by pH change whether an acceptable concentration of a sanitizing or disinfecting composition exists with a mechanism permitting an at-a-glance determination.

In embodiments, a color changing resin composition comprises: a resin backbone with a heterocyclic cationic group; and a pH-sensitive sulfonated dye linked complexed to the resin backbone, wherein the pH sensitive dye is a sulfonated dye, carboxylate dye, or nitrated dye, and wherein the composition is a water insoluble polymer. The resin backbones can include a polyalkylene, polyacrylate, polycarbonate, polyarylene, polyaryletherketone, or polyamide-imides, and wherein the nitrogen-containing heterocyclic cationic group is pyrrolium, imidazolium, pyrazolium, oxazolium, thiazolium, pyridinium, pyrimidinium, pyrazinium, pyradizimium, thiazinium, morpholinium, piperidinium, piperizinium, or pyrollizinium. In further embodiments, the polyalkylene resin backbone is a vinyl polymer. In further embodiments, the resin backbone is a polyethylene, polypropylene, polyalkylacrylates, polystyrene, polyurethane, polyvinyl chloride, polyphenol-aldehyde, polytetrafluoroethylene, polybutylene terephthalate, polycaprolactam, and/or poly(acrylonitrile butadiene styrene). In any of the embodiments, the resin backbone is insoluble and is crosslinked or un-crosslinked. In any of the embodiments, the pH-sensitive sulfonated dye is an azo dye comprising one or more diazenyl functional groups with the following structure:

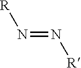

wherein R is an aryl group or an alkyl group having between 2 and 20 carbons, and wherein R′ is an aryl group or an alkyl group having between 2 and 20 carbons. In preferred embodiments, the azo dye is Allura red AC, azo violet, basic red 18, bromothymol blue, Congo red, direct blue 1, direct brown 103, direct brown 186, direct brown 78, direct red 79, direct black 19, m-cresol purple, methyl orange, methyl red, para red, phenol red, reactive orange 16, tartrazine, thymol blue, xylenol blue, xylenol orange, alizarin yellow, or a combination thereof. In embodiments, the pH-sensitive dye exhibits a visual change in color at an acidic or base indicator pH range. Beneficially according to any of the embodiments the composition is reusable and can be in the form of beads, rods, sheets, or strips.

In embodiments a kit comprises: the color changing resin compositions described herein and a container and/or instructions for use. The kits can further include at least one additional component selected from the group consisting of an alkaline composition, an acidic composition, or combinations thereof. In embodiments, the alkaline composition or the acidic composition are cleaning and/or sanitizing compositions. In any of the embodiments, instructions for use can be further included and comprise a visual depiction of the colors of the color changing resin composition at predetermined pH ranges.

In an embodiment, as described herein, comprises a method of synthesizing the color changing resin compositions described herein comprises: introducing a nitrogen-containing heterocyclic cationic group onto a resin backbone via a quaternization reaction with a heterocyclic amine to form a resin backbone with the nitrogen-containing heterocyclic cationic group; thereafter replacing the cationic group of the resin backbone with a pH-sensitive sulfonated dye via anion exchange to form a color changing resin composition, wherein the pH-sensitive dye is sulfonated, carboxylated or nitrated, and wherein the composition is a water insoluble polymer. In embodiments, the nitrogen-containing heterocyclic cationic group is pyrrolium, imidazolium, pyrazolium, oxazolium, thiazolium, pyridinium, pyrimidinium, pyrazinium, pyradizimium, thiazinium, morpholinium, piperidinium, piperizinium, or pyrollizinium, and/or wherein the resin backbone is a polyalkylene, polyacrylate, polycarbonate, polyarylene, polyaryletherketone, or polyamide-imides. In embodiments, the resin backbone is a polyethylene, polypropylene, polyalkylacrylates, polystyrene, polyurethane, polyvinyl chloride, polyphenol-aldehyde, polytetrafluoroethylene, polybutylene terephthalate, polycaprolactam, and/or poly(acrylonitrile butadiene styrene). In embodiments, the resin backbone is water insoluble and is crosslinked or un-crosslinked. In embodiments, the resin backbone is a vinyl polymer. In embodiments, the resin backbone is a crosslinked polystyrene resin. In any of the embodiments, the quaternization reaction can take place under stirring or agitation for a period of at least 1 to at least 20 about 12 hours, and at a temperature of about 50° C. to about 90° C. In any of the embodiments, the resin backbone with the nitrogen-containing heterocyclic cationic group is a slurry, e.g. wherein the slurry is washed with deionized water and an alcohol (e.g. ethanol) and/or dried (e.g. air dried). In any of the embodiments, the dried polymer resin is added into an aqueous solution of the pH sensitive sulfonated dye and/or DI water is added to the dried polymer resin before ethe anion exchange reaction. In any of the embodiments, the anion exchange reaction adds the pH-sensitive dye in an aqueous solution under stirring or agitation at room temperature, e.g. wherein the stirring or agitation for the anion exchange reaction takes place for a period of at least about 30 minutes to at least about 5 hours. In any of the embodiments, the pH-sensitive sulfonated dye is an azo dye comprising one or more diazenyl functional groups with the following structure:

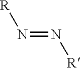

wherein R is an aryl group or an alkyl group having between 2 and 20 carbons, and wherein R′ is an aryl group or an alkyl group having between 2 and 20 carbons. In any of the embodiments, the azo dye is Allura red AC, azo violet, basic red 18, bromothymol blue, Congo red, direct blue 1, direct brown 103, direct brown 186, direct brown 78, direct red 79, direct black 19, m-cresol purple, methyl orange, methyl red, para red, phenol red, reactive orange 16, tartrazine, thymol blue, xylenol blue, xylenol orange, alizarin yellow, or a combination thereof. In any of the embodiments, the color changing resin composition can be filtered. In any of the embodiments, the color changing resin composition can be washed with deionized water until an effluent is approximately neutral. In any of the embodiments, the color changing resin composition are reusable, water insoluble, solid beads, rods, sheets, or strips. Another preferred embodiment, as described herein, comprises a method of use comprising: visually detecting a color change in a composition comprising the color changing resin composition as described herein. In an embodiment, the composition further comprises an alkaline composition, an acidic composition, or combinations thereof. In further embodiments, the alkaline composition or the acidic composition are cleaning and/or sanitizing compositions. In any of the embodiments, the color change indicates a change in pH outside of a predetermined range for one or more of the following: concentration of an active within a use solution, safety in contacting with or without PPE, or combinations thereof.

These and/or other objects, features, advantages, and/or embodiments will become apparent to those skilled in the art after reviewing the following brief and detailed descriptions of the drawings. Furthermore, the present disclosure encompasses embodiments not expressly disclosed but which can be understood from a reading of the present disclosure, including at least: (a) combinations of disclosed embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The patent or application file contains at least one drawing executed in color.

Copies of this patent or patent application publication with color drawing(s) will be provided by the Office upon request and payment of the necessary fee.

FIGS. 1A-1R show exemplary dyes for use in the color changing resin compositions.

FIG. 2 shows the first step in the synthesis of a polymer resin composition with the backbone quaternization reaction with a heterocyclic amine as described in Example 1.

FIG. 3 shows the second step in the synthesis of a pH-sensitive polymer resin composition where anion exchange replaces cationic charge of the backbone with a sulfonated dye as described in Example 1.

FIG. 4 shows the shifting of double bond structure in an azo dye dependent on pH conditions.

FIG. 5 is a photograph showing the colors of resin beads (A) containing methylimidazolium chloride in DI water, (B) containing methylimidazolium dye-sulfonate in DI water, and (C) containing methylimidazolium dye-sulfonate in DI water following addition of HC1 to bring pH below 2 as described in Example 2.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION OF THE PREFERRED EMBODIMENTS

The present disclosure relates to color changing resin compositions for various applications, methods of use, and methods of synthesis thereof. The color changing resin compositions have advantages over methods of detecting a concentration or presence of an active concentration in a cleaning composition. The embodiments described herein are not limited to particular compositions, methods of making and/or methods of use which can vary and are understood by skilled artisans.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

### Definitions

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring techniques and equipment, with respect to any quantifiable variable, including, but not limited to, mass, volume, time, temperature, pH, and log count of bacteria or viruses. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including hetero aromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “antimicrobial” refers to a compound or composition that reduces and/or inactivates a microbial population, including, but not limited to bacteria, viruses, fungi, and algae within about 10 minutes or less, about 8 minutes or less, about 5 minutes or less, about 3 minutes or less, about 2 minutes or less, about 1 minute or less, or about 30 seconds or less. Preferably, the term antimicrobial refers to a composition that provides at least about a 3-log, 3.5 log, 4 log, 4.5 log, or 5 log reduction of a microbial population in about 10 minutes or less, about 8 minutes or less, about 5 minutes or less, about 3 minutes or less, about 2 minutes or less, about 1 minute or less, or about 30 seconds or less.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

The term “hard surface” refers to a solid, substantially non-flexible surface such as a countertop, tile, floor, wall, panel, window, plumbing fixture, kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein, the phrase “health care surface” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in hospital, surgical, infirmity, birthing, mortuary, and clinical diagnosis rooms. These surfaces can be those typified as “hard surfaces” (such as walls, floors, bed-pans, etc.,), or fabric surfaces, e.g., knit, woven, and non-woven surfaces (such as surgical garments, draperies, bed linens, bandages, etc.,), or patient-care equipment (such as respirators, diagnostic equipment, shunts, body scopes, wheelchairs, beds, etc.,), or surgical and diagnostic equipment. Health care surfaces include articles and surfaces employed in animal health care.

As used herein, the term “instrument” refers to the various medical or dental instruments or devices that can benefit from cleaning with a composition according to the present invention. As used herein, the phrases “medical instrument,” “dental instrument,” “medical device,” “dental device,” “medical equipment,” or “dental equipment” refer to instruments, devices, tools, appliances, apparatus, and equipment used in medicine or dentistry. Such instruments, devices, and equipment can be cold sterilized, soaked or washed and then heat sterilized, or otherwise benefit from cleaning in a composition of the present invention. These various instruments, devices and equipment include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressers, trocars, dilators, cages, glassware, tubing, catheters, cannulas, plugs, stents, scopes (e.g., endoscopes, stethoscopes, and arthroscopes) and related equipment, and the like, or combinations thereof.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “sanitizer” refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used herein, the term “soft surface” refers to surfaces not classified as hard surfaces, but which are solid surfaces. Soft surfaces, include, but are not limited to, textiles, fabrics, woven surfaces, and non-woven surfaces. Soft surfaces, include, but are not limited to, carpet, curtains, fabrics, hospital partitions, linens, and upholstery.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “virus”, as used herein refers to a type of microorganism that can include both pathogenic and non-pathogenic viruses. Pathogenic viruses can be classified into two general types with respect to the viral structure: enveloped viruses and non-enveloped viruses. Some well-known enveloped viruses include herpes virus, influenza virus; paramyxovirus, respiratory syncytial virus, corona virus, HIV, hepatitis B virus, hepatitis C virus and SARS-CoV virus. Non-enveloped viruses, sometimes referred to as “naked” viruses, include the families Picornaviridae, Reoviridae, Caliciviridae, Adenoviridae and Parvoviridae. Members of these families include rhinovirus, poliovirus, adenovirus, hepatitis A virus, norovirus, papillomavirus, and rotavirus. It is known in the art that “enveloped” viruses are relatively sensitive and, thus, can be inactivated by commonly used disinfectants. In contrast, non-enveloped viruses are substantially more resistant to conventional disinfectants and are significantly more environmentally stable than enveloped viruses.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the invention include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the invention include polyethylene terephthalate (PET) polystyrene polyamide.

The terms “water soluble” and “water dispersible” as used herein, means that the ingredient is soluble or dispersible in water in the inventive compositions. In general, the ingredient should be soluble or dispersible at 25° C. concentration of between about 0.1 wt-% and about 15 wt-% of the water, more preferably at a concentration of between about 0.1 wt-% and about 10 wt-%.

The term “water insoluble” as used herein means that the ingredient is insoluble and not dispersible in water. In general, the ingredient (namely the color changing resin composition) is insoluble or practically insoluble in that it does not or almost does not dissolve in water. In an embodiment, water insoluble material is outside the scope of the water solubility as defined herein, and can be further quantified as a material that when 1 gram of material is added to water requires more than 10,000 ml of the water to dissolve or does not dissolve in any amount whatsoever.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods and compositions may comprise, consist essentially of, or consist of the components and ingredients as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Color Changing Resin Compositions

The color changing resin compositions provide color changing resin compositions that are pH sensitive such that the resin compositions exhibit a visual color change upon a change (i.e., increase or decrease) of pH for the specific dye on the resin backbone. The color changing resin compositions are water insoluble polymers and therefore are not swellable polymers. In further embodiments the color changing resin compositions are also insoluble in aqueous and organic solvents. Beneficially, the compositions are reusable allowing them to be used as indicators providing visual color change upon increases and decreases of pH over an extended period of time. In preferred embodiments the compositions are insoluble polymer beads, rods, sheets, strips, or the like.

The color changing resin compositions can be reused as indicators for visual color change upon pH changes over an extended period of time, including from a few months to a few years, such as at least about 1 month to at least about 5 years, or at least about 3 months to at least about 3 years, or at least about 3 months to at least about 1 year. In certain embodiments, the compositions may become exhausted through the slow leaching of dye and may require regeneration for re-use, such as through the anion exchange by dye again. This beneficially provides a readily available way to further extend the period of time the color changing resin compositions can be employed and provides a reusable material.

The color changing resin compositions comprise a sulfonated dye (can also be referred to as a pH sensitive sulfonated dye) complexed to a resin backbone to allow for visual change in color of the composition upon a change in pH. The sulfonated dye is complexed (i.e., ionic interaction) to the resin back bone, such as by covalent and ionic bonding. A color change of these compositions, which are water insoluble polymers, provides a visual indicator to a use of a composition containing the color changing resin composition that a change in pH has occurred. Thus, the pH sensitive sulfonated dye provides an at-a-glance real-time determination of a composition's pH and/or active concentration which can provide significant utility for sanitizing and/or disinfecting efficacy.

### Resin Backbones

The color changing resin compositions comprise a resin backbone with a sulfonated dye complexed thereto. The resins are a polymeric backbone, which can be crosslinked or un-crosslinked solid polymer backbones. In most embodiments the resin backbone is crosslinked to provide desired water insolubility. Preferably the resin backbones are heterocyclic. Examples of suitable resin backbones include polyalkylenes, polyacrylates, polycarbonate, polyarylenes, polyaryletherketones, and polyamide-imides. In certain embodiments the resin backbone is a polyalkylene resin backbone, preferably a vinyl polymer. Vinyl polymers have extended alkane chain backbones, such as polyethylene, polypropylene, polystyrene, polyvinyl chloride (PVC), polyvinyl acetate (PVA), and polyacrylonitrile. As one skilled in the art will ascertain from the disclosure herein, the resin backbones containing a heterocyclic group can be introduced as a polymer or by monomer selection to make a polymer backbone, or by post-functionalization of polymer with a heterocyclic group. The selection of method of providing a resin backbone with a heterocyclic group is not intended to be a limiting step or selection.

In certain embodiments, the polymeric backbone is a polyethylene, polypropylene, polyalkylacrylates, polystyrene, polyurethane, polyvinyl chloride, polyphenol-aldehyde, polytetrafluoroethylene, polybutylene terephthalate, polycaprolactam, and/or poly(acrylonitrile butadiene styrene). In certain preferred embodiments, the polymeric backbone is a crosslinked polyethylene, polypropylene, polyalkylacrylates, polystyrene, polyurethane, polyvinyl chloride, polyphenol-aldehyde, polytetrafluoroethylene, polybutylene terephthalate, polycaprolactam, and/or poly(acrylonitrile butadiene styrene).

### pH Sensitive Sulfonated Dyes

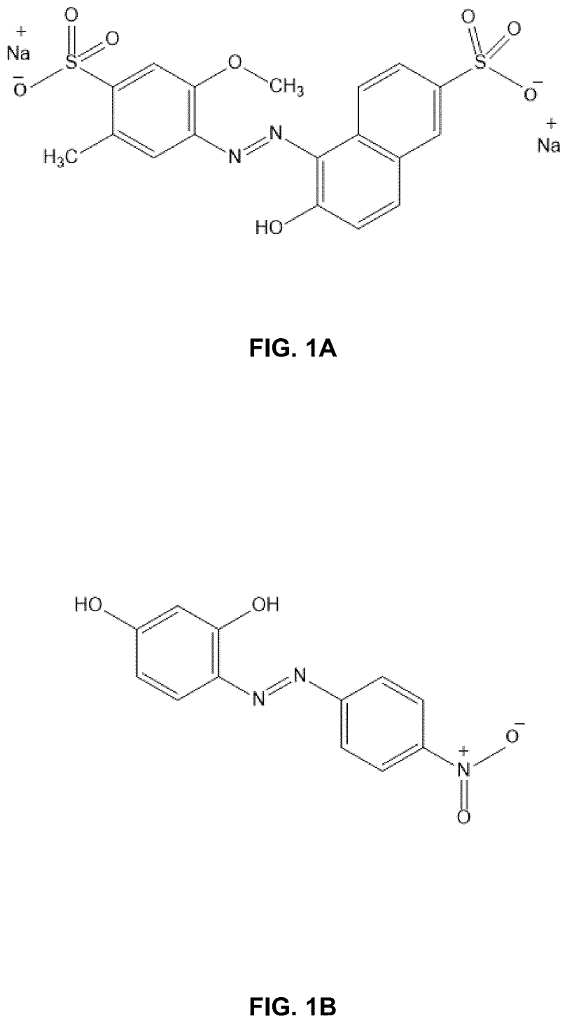

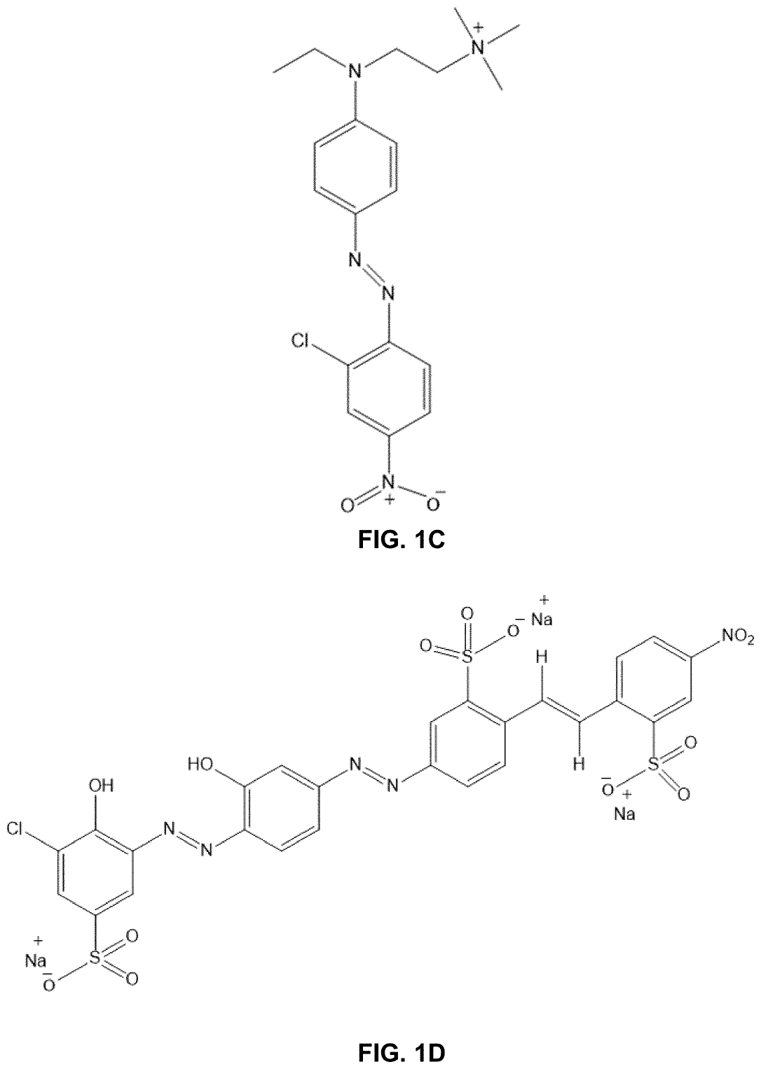

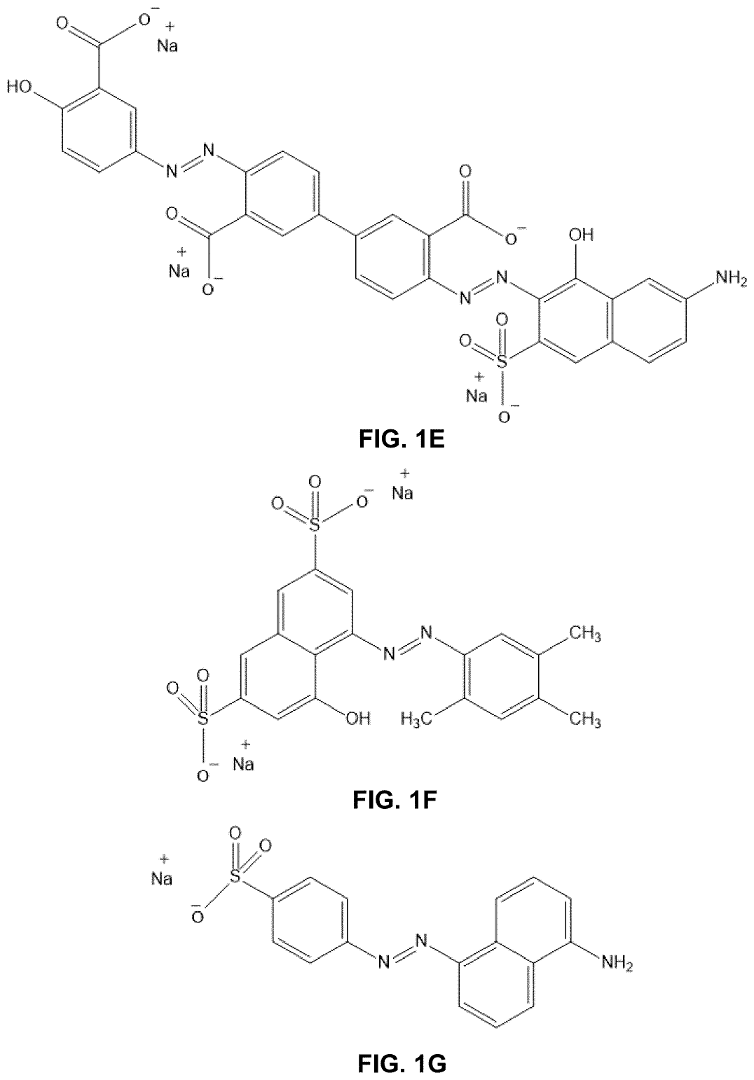

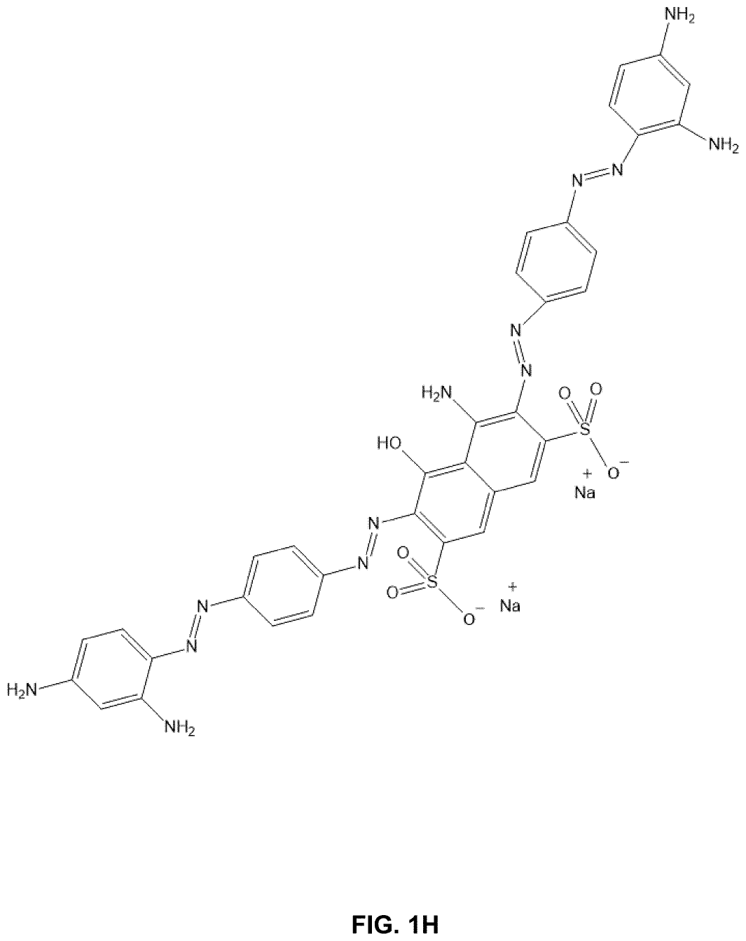

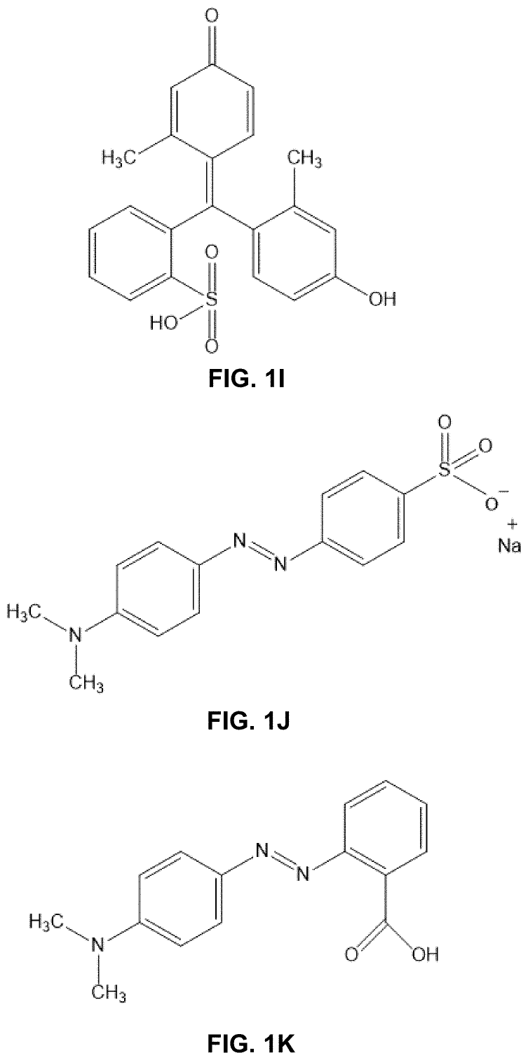

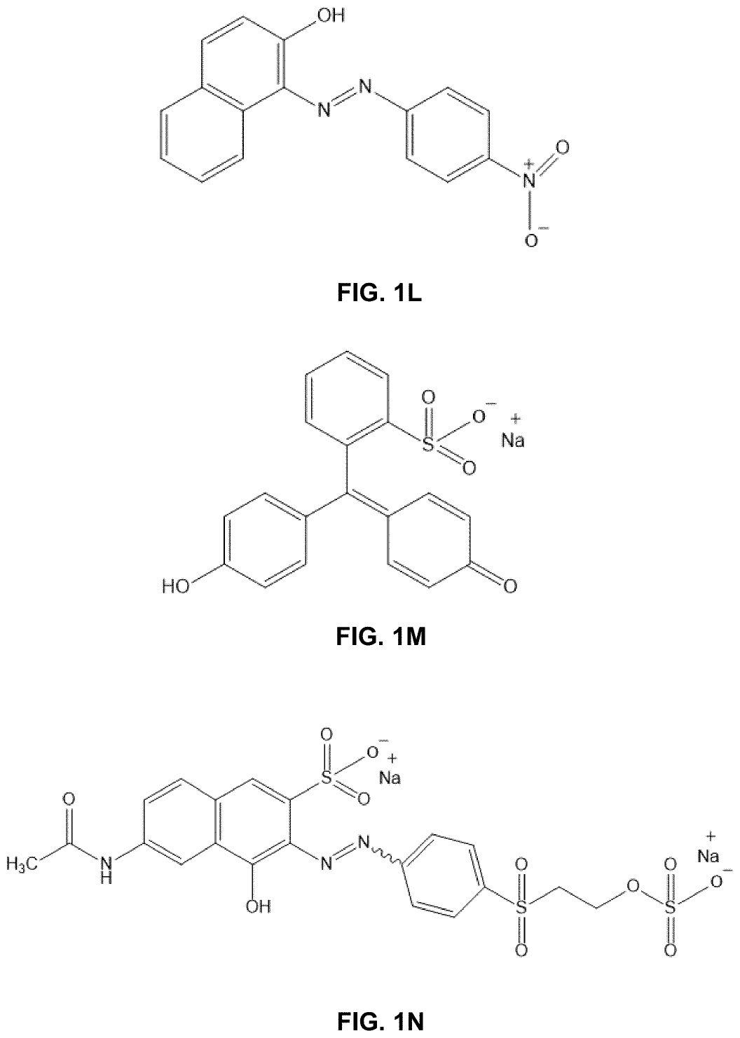

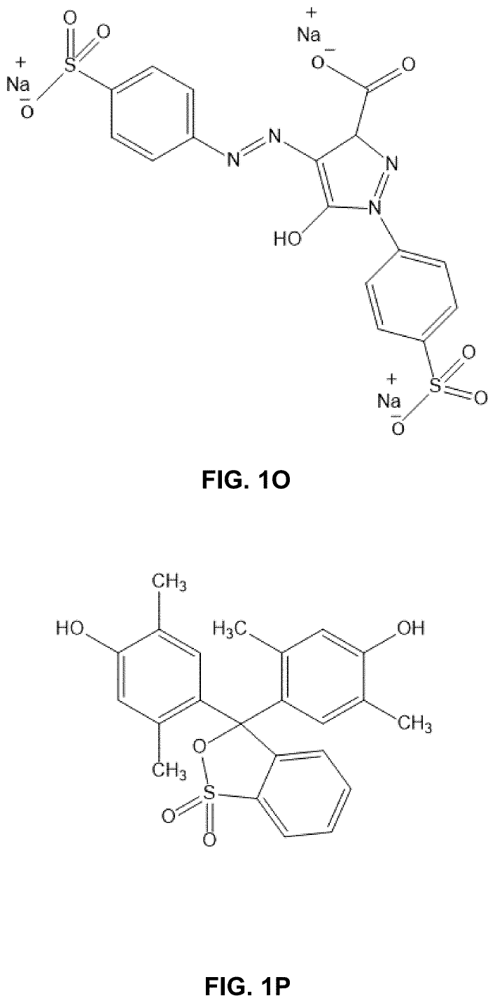

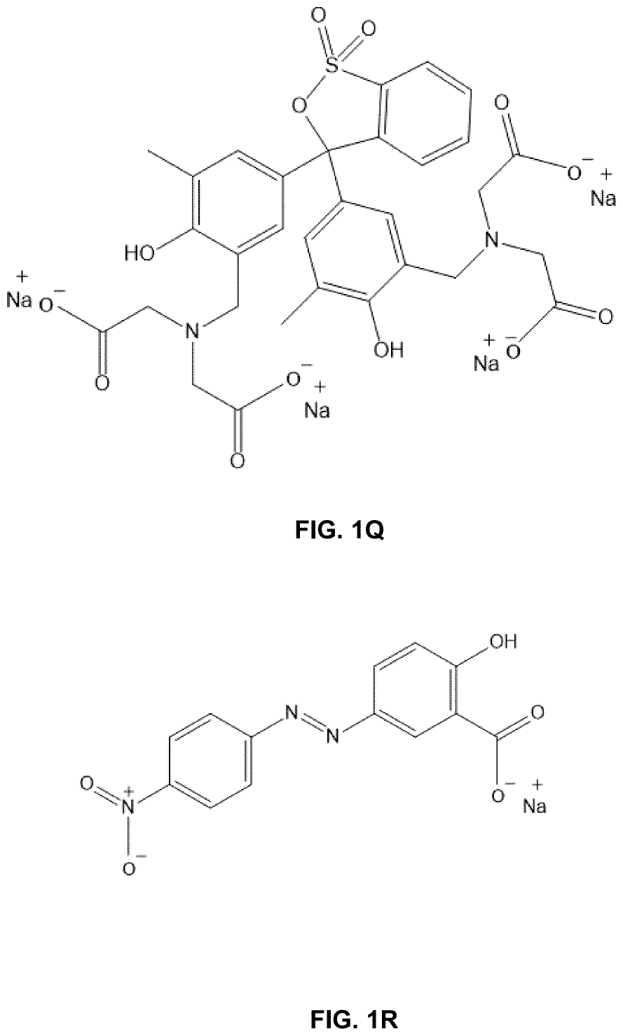

The color changing resin compositions comprise a pH sensitive dye. pH sensitive dyes can include sulfonated dye (can also be referred to as a pH sensitive sulfonated dye), carboxylated dye (can also be referred to as a pH sensitive carboxylated dye) or nitrated dye (can also be referred to as a pH sensitive nitrated dye) complexed to a resin backbone. Exemplary structures for pH sensitive dyes are shown in FIGS. 1A-1R, including allura red AC (FIG. 1A), azo violet (FIG. 1B), basic red 18 (FIG. 1C), direct brown 103 (FIG. 1D), direct brown 186 (FIG. 1E), CI direct red 79 (FIG. 1F), CI direct brown 78 (FIG. 1G), CI direct black 19 (FIG. 1H), m-cresol purple (FIG. 1I), methyl orange (FIG. 1J), methyl red (FIG. 1K), para red (FIG. 1L), phenol red (FIG. 1M), reactive orange 16 (FIG. 1N), tartrazine (FIG. 10), xylenol blue (FIG. 1P), xylenol orange (FIG. 1Q), and alizarin yellow (FIG. 1R). The pH sensitive dyes change color at a predetermined pH range. The sulfonated dyes shown in FIGS. 1A-1R are more readily commercially available, however additional structures for any of the sulfonated, carboxylated, or nitrated dyes can be employed in the color changing resin compositions.

The pH sensitive dyes can comprise an azo dye or a combination or mixture of dyes including mixtures comprised of two or more azo dyes. Azo dyes are organic compounds comprising one or more diazenyl functional groups:

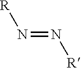

wherein R and R′ are either an aryl group or an alkyl group. Preferred azo dyes include those where R has between 2 and 20 carbons, more preferably between 4 and 16 carbons, and where R′ has between 2 and 20 carbons, more preferably between 4 and 16 carbons. For a more detailed description of suitable azo dyes, see U.S. Pat. No. 4,029,598 at column 2, line 7 through column 5, line 68, which is incorporated herein by reference in its entirety.

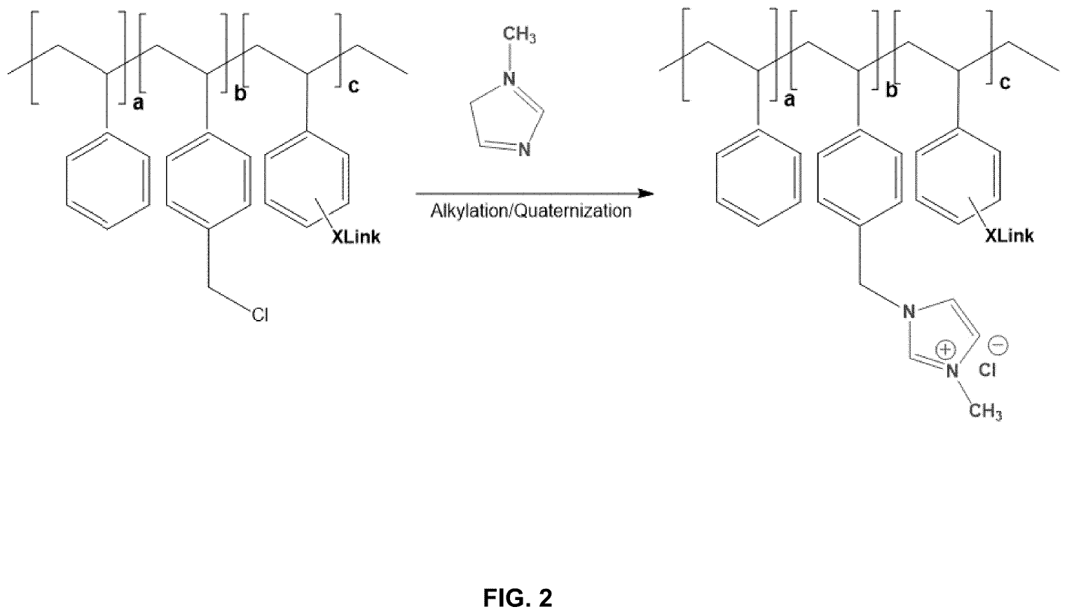

The azo dyes are preferred sulfonated, carboxylated or nitrated dyes as their structure allows for the shifting of the double bonds, see e.g. FIG. 2 showing a sulfonated dye, at a pH condition which results in a color change of the dye. Preferred azo dyes include, but are not limited to, Allura red AC, azo violet, basic red 18, bromothymol blue, Congo red, direct blue 1, direct brown 103, direct brown 186, direct brown 78, direct red 79, direct black 19, m-cresol purple, methyl orange, methyl red, para red, phenol red, reactive orange 16, tartrazine, thymol blue, xylenol blue, xylenol orange, alizarin yellow, and combinations or mixtures thereof.

In embodiments the pH sensitive dye changes color at an acidic or base indicator pH range. In embodiments, the pH sensitive dye exhibits a color change at a pH of at about 12 or less, at about 11.9 or less, at about 11.8 or less, at about 11.7 or less, at about 11.6 or less, about 11.5 or less, at about 11.4 or less, at about 11.3 or less, at about 11.2 or less, at about 11.1 or less, at about 11 or less, at about 10.9 or less, at about 10.8 or less, at about 10.7 or less, at about 10.6 or less, about 10.5 or less, at about 10.4 or less, at about 10.3 or less, at about 10.2 or less, at about 10.1 or less, at about 10 or less, at about 9.9 or less, at about 9.8 or less, at about 9.7 or less, at about 9.6 or less, about 9.5 or less, at about 9.4 or less, at about 9.3 or less, at about 9.2 or less, at about 9.1 or less, at about 9 or less, at about 8.9 or less, at about 8.8 or less, at about 8.7 or less, at about 8.6 or less, about 8.5 or less, at about 8.4 or less, at about 8.3 or less, at about 8.2 or less, at about 8.1 or less, at about 8 or less, at about 7.9 or less, at about 7.8 or less, at about 7.7 or less, at about 7.6 or less, about 7.5 or less, at about 7.4 or less, at about 7.3 or less, at about 7.2 or less, at about 7.1 or less, at about 7 or less, at about 6.9 or less, at about 6.8 or less, at about 6.7 or less, at about 6.6 or less, about 6.5 or less, at about 6.4 or less, at about 6.3 or less, at about 6.2 or less, at about 6.1 or less, at about 6 or less, at about 5.9 or less, at about 5.8 or less, at about 5.7 or less, at about 5.6 or less, about 5.5 or less, at about 5.4 or less, at about 5.3 or less, at about 5.2 or less, at about 5.1 or less, at about 5 or less, at about 4.9 or less, at about 4.8 or less, at about 4.7 or less, at about 4.6 or less, about 4.5 or less, at about 4.4 or less, at about 4.3 or less, at about 4.2 or less, at about 4.1 or less, about 4 or less, at about 3.9 or less, at about 3.8 or less, at about 3.7 or less, at about 3.6 or less, at about 3.5 or less, at about 3.4 or less, at about 3.3 or less, at about 3.2 or less, at about 3.1 or less, at about 3.0 or less, at about 2.9 or less, at about 2.8 or less, at about 2.7 or less, at about 2.6 or less, at about 2.5 or less, at about 2.4 or less, at about 2.3 or less, at about 2.2 or less, at about 2.1 or less, at about 2.0 or less, at about 1.9 or less, at about 1.8 or less, at about 1.7 or less, at about 1.6 or less, at about 1.5 or less, at about 1.4 or less, at about 1.3 or less, at about 1.2 or less, at about 1.1 or less, at about 1.0 or less, at about 0.9 or less, at about 0.8 or less, at about 0.7 or less, at about 0.6 or less, at about 0.5 or less, at about 0.4 or less, at about 0.3 or less, or at about 0.2 or less.

In exemplary embodiments, the pH sensitive sulfonated dye exhibits a color change at a pH between about 2 and about 4.5, more preferably between about 2.2 and about 4.0, still more preferably between about 2.5 and about 3.5, or most preferably at a pH between about 2.8 and about 3.2. In a preferred embodiment, the pH sensitive dye has a pKa between about 2 and about 4.5, more preferably between about 2.2 and about 4, most preferably between about 2.5 and about 3.5.

In exemplary embodiments as set forth in Table 1, the pH sensitive dye cresol red exhibits a color change at a pH between about 0.2 and about 1.8; the pH sensitive dye malachite green exhibits a color change at a pH between about 0.2 and about 1.8; the pH sensitive dye thymol blue exhibits a color change at a pH between about 1.2 and about 2.8; the pH sensitive dye methyl yellow exhibits a color change at a pH between about 2.9 and about 4.0; the pH sensitive dye methyl orange exhibits a color change at a pH between about 3.1 and about 4.4; the pH sensitive dye bromophenol blue exhibits a color change at a pH between about 3.0 and about 4.6; the pH sensitive dye Congo red exhibits a color change at a pH between about 3.0 and about 5.0; the pH sensitive dye methyl orange in xylene cyanol exhibits a color change at a pH between about 3.2 and about 4.2; the pH sensitive dye bromocresol green exhibits a color change at a pH between about 3.8 and about 5.4; the pH sensitive dye methyl red exhibits a color change at a pH between about 4.4 and about 6.2; the pH sensitive dye methyl purple exhibits a color change at a pH between about 4.8 and about 5.4; the pH sensitive dye bromocresol purple exhibits a color change at a pH between about 5.2 and about 6.8; the pH sensitive dye azolitmin exhibits a color change at a pH between about 4.5 and about 8.3; the pH sensitive dye bromothymol blue exhibits a color change at a pH between about 6.0 and about 7.6; the pH sensitive dye phenol red exhibits a color change at a pH between about 6.4 and about 8.0; the pH sensitive dye neutral red exhibits a color change at a pH between about 6.8 and about 8.0; the pH sensitive dye cresol red exhibits a color change at a pH between about 7.2 and about 8.8; the pH sensitive dye naphtholphthalein exhibits a color change at a pH between about 7.3 and about 8.7; the pH sensitive dye thymol blue exhibits a color change at a pH between about 8.0 and about 9.6; the pH sensitive dye cresolphthalein exhibits a color change at a pH between about 8.2 and about 9.8; the pH sensitive dye phenolphthalein exhibits a color change at a pH between about 8.3 and about 10.0; the pH sensitive dye thymolphthalein exhibits a color change at a pH between about 9.0 and about 10.5; the pH sensitive dye alizarin yellow R exhibits a color change at a pH between about 10.1 and about 12.0; the pH sensitive dye indigo carmine exhibits a color change at a pH between about 11.4 and about 13.0; the pH sensitive dye malachite green exhibits a color change at a pH between about 11.5 and about 13.2.

TABLE 1

| | pH | pH | | Low pH | High pH |
|---|---|---|---|---|---|
| Trade Name | start | end | pKa | color | color |
| Cresol red - step 1 | 0.2 | 1.8 | 1.0 | red | yellow |
| Malachite green - step 1 | 0.2 | 1.8 | 1.3 | yellow | green |
| Thymol blue - step 1 | 1.2 | 2.8 | 1.7 | red | yellow |
| Methyl yellow | 2.9 | 4.0 | 3.3 | red | yellow |
| Methyl orange | 3.1 | 4.4 | 3.5 | red | yellow |
| Bromophenol blue | 3.0 | 4.6 | 4.1 | yellow | blue |
| Congo red | 3.0 | 5.0 | | blue-violet | red |
| Methyl orange in xylene | 3.2 | 4.2 | | grey-violet | green |
| cyanol (screened) | | | | | |
| Bromocresol green | 3.8 | 5.4 | 4.7 | yellow | blue |
| Methyl red | 4.4 | 6.2 | 5.1 | red | yellow |
| Methyl purple | 4.8 | 5.4 | | purple | green |
| Bromocresol purple | 5.2 | 6.8 | 6.4 | yellow | purple |
| Azolitmin (litmus) | 4.5 | 8.3 | | red | blue |
| Bromothymol blue | 6.0 | 7.6 | 7.3 | yellow | blue |
| Phenol red | 6.4 | 8.0 | 8.0 | yellow | red |
| Neutral red | 6.8 | 8.0 | | red | yellow |
| Cresol red - step 2 | 7.2 | 8.8 | 8.5 | yellow | reddish- |
| | | | | | purple |
| Naphtholphthalein | 7.3 | 8.7 | | pale red | greenish- |
| | | | | | blue |
| Thymol blue - step 2 | 8.0 | 9.6 | 9.2 | yellow | blue |
| Cresolphthalein | 8.2 | 9.8 | | colorless | purple |
| Phenolphthalein | 8.3 | 10.0 | 9.5 | colorless | red-pink |
| Thymolphthalein | 9.0 | 10.5 | 9.2 | colorless | blue |
| Alizarin yellow R | 10.1 | 12.0 | 11.2 | yellow | red |
| Indigo carmine | 11.4 | 13.0 | | blue | yellow |
| Malachite green - step 2 | 11.5 | 13.2 | | green | colorless |

### Kits

The present disclosure provides a kit comprising the color changing resin composition; and a container and/or instructions for use. In embodiments, the kit can further include at least one additional component selected from the group consisting of an alkaline composition, an acidic composition, or combinations thereof. In embodiments, the alkaline composition or the acidic composition are cleaning and/or sanitizing compositions. In embodiments, the instructions for use can comprise a visual depiction (i.e. photograph or image) of the colors of the color changing resin composition at predetermined pH ranges.

### Methods of Synthesis

The present disclosure provides methods of making the color changing resin composition. Methods of synthesizing the color changing resin composition are achieved through a two-step process comprising first introducing a nitrogen-containing heterocyclic cationic group onto a resin backbone via a quaternization reaction with a heterocyclic amine to form a resin backbone with the nitrogen-containing heterocyclic cationic group, and thereafter replacing the cationic group of the resin backbone with a pH-sensitive sulfonated dye to form a color changing resin composition, wherein the composition is a water insoluble polymer.

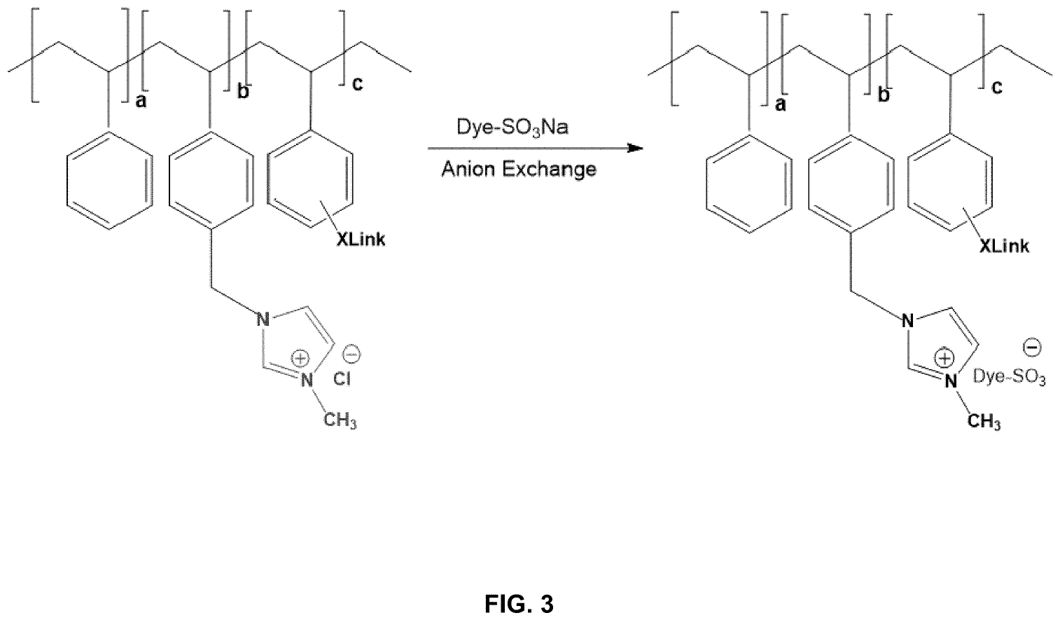

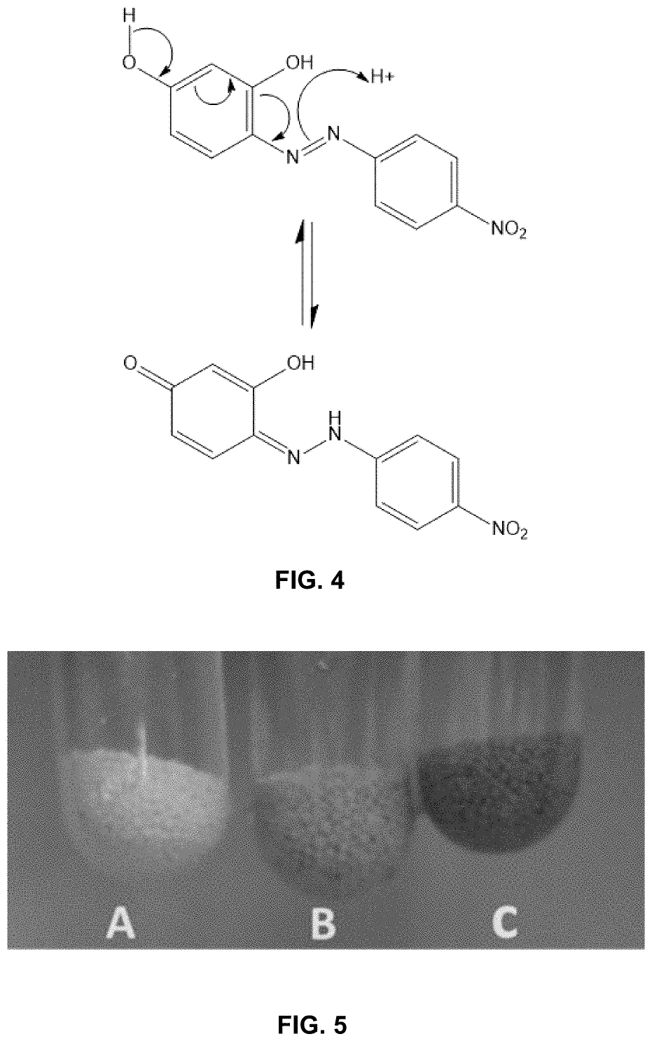

The general reaction scheme is further illustrated in FIG. 3 showing the first step of synthesizing the color changing resin composition, wherein a nitrogen-containing heterocyclic cationic group is introduced onto a resin backbone (depicted as a crosslinked polystyrene resin) via a quaternization reaction with a heterocyclic amine. FIG. 4 shows the second step of the reaction scheme where the cation (depicted as Cl⁻) of the resulting resin backbone (depicted as the crosslinked polystyrene resin) is replaced by anion exchange with the pH-sensitive sulfonated dye.

Any of the resin backbones described herein can be used in the methods, including crosslinked or un-crosslinked solid resin backbones, including polyalkylenes, polyacrylates, polycarbonate, polyarylenes, polyaryletherketones, and polyamide-imides. In embodiments the resin backbone is a polyalkylene resin backbone, preferably a vinyl polymer. Vinyl polymers have extended alkane chain backbones, such as polyethylene, polypropylene, polystyrene, polyvyinyl chloride (PVC), polyvinyl acetate (PVA), and polyacrylonitrile. In embodiments, the polymeric backbone is a polyethylene, polypropylene, polyalkylacrylates, polystyrene, polyurethane, polyvinyl chloride, polyphenol-aldehyde, polytetrafluoroethylene, polybutylene terephthalate, polycaprolactam, and/or poly(acrylonitrile butadiene styrene). In certain preferred embodiments, the polymeric backbone is a crosslinked polyethylene, polypropylene, polyalkylacrylates, polystyrene, polyurethane, polyvinyl chloride, polyphenol-aldehyde, polytetrafluoroethylene, polybutylene terephthalate, polycaprolactam, and/or poly(acrylonitrile butadiene styrene).

In embodiments, the quaternization reaction to introduce the nitrogen-containing heterocyclic cationic group onto the resin backbone takes place under stirring or agitation conditions. In embodiments. the quaternization reaction takes place under the stirring or agitation conditions for a period of at least about 1 to at least about 24 hours, at least about 1 to at least about 20 hours, at least about 5 to at least about 20 hours, or at least about 8 to at least about 20 hours. In still further embodiments, the quaternization reaction takes place at a temperature of about 50° C. to about 90° C., about 60° C. to about 90° C., or about 60° C. to about 80° C.

In embodiments, the quaternization reaction provides the resin backbone with the nitrogen-containing heterocyclic cationic group in the form of a slurry of the polymer resin. Thereafter the methods can include the step of washing the slurry of polymer resin with deionized water and an alcohol (e.g. ethanol). Thereafter the methods can further include the step of drying (e.g. air dried) the washed slurry of polymer resin.

In embodiments, a heterocyclic amine provides a nitrogen-containing heterocyclic cationic group that can include pyrrolium, imidazolium, pyrazolium, oxazolium, thiazolium, pyridinium, pyrimidinium, pyrazinium, pyradizimium, thiazinium, morpholinium, piperidinium, piperizinium, and pyrollizinium. The corresponding heterocyclic amines to provide the cationic groups would include pyrrole, imidiazole, pyrazole, oxazole, thiazole, pyridine, pyrimidine, pyrazole, pyridazine, thiazine, morpholine, piperdine, piperazine and pyrollizine.

In embodiments, the anion exchange to replace the cationic group of the resin backbone with the pH-sensitive sulfonated dye to form the color changing resin composition, takes place under stirring or agitation conditions at room temperature. As described herein, room temperature includes temperature from about 18° C. to about 25° C., or from about 20° C. to about 22° C. In embodiments, the anion exchange reaction is a fast reaction that takes place under the stirring or agitation conditions for a period of up to about 12 hours. In embodiments, the anion exchange reaction takes place under the stirring or agitation conditions for a period of at least about 30 minutes to at least about 5 hours, at least 1 hour to at least about 4 hours, or at least 1 hour to at least 3 hours. The anion exchange reaction can use various conventional anion exchange techniques, such as for example a column where solution is poured over the resin beads (or other form) and flows by gravity.

In embodiments where the resin backbone with the nitrogen-containing heterocyclic cationic group was dried, a step of forming a solution of the resin backbone can take place. In embodiments DI water can be added to the resin backbone with the nitrogen-containing heterocyclic cationic group. In other embodiments the resin backbone with the nitrogen-containing heterocyclic cationic group can be added to an aqueous solution of the pH sensitive sulfonated dye.

Any of the pH sensitive sulfonated dyes described herein can be used in the methods, including azo dyes or mixture of dyes including mixtures comprised of two or more azo dyes. Azo dyes are organic compounds comprising one or more diazenyl functional groups:

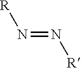

wherein R and R′ are either an aryl group or an alkyl group. Preferred azo dyes include those where R has between 2 and 20 carbons, more preferably between 4 and 16 carbons, and where R′ has between 2 and 20 carbons, more preferably between 4 and 16 carbons. In embodiments the azo dyes can include, but are not limited to, Allura red AC, azo violet, basic red 18, bromothymol blue, Congo red, direct blue 1, direct brown 78, m-cresol purple, methyl orange, methyl red, para red, phenol red, reactive orange 16, tartrazine, thymol blue, xylenol blue, xylenol orange, and combinations or mixtures thereof. Various additional pH sensitive dyes (sulfonated and/or carboxylated) can be employed herein to make the color changing resin compositions.

In embodiments, following the anion exchange reaction the color changing resin composition can be filtered, including filtered under vacuum. In further embodiments, the methods of forming the color changing resin composition can also include the step of washing the color changing resin composition with deionized water until there is a neutral effluent. The color changing resin compositions can further be dried.

The color changing resin compositions can be in the form of beads, rods, sheets, strips, or the like. There is no limitation to the size of these compositions, although the application of use will impact the size limitations.

### Methods of Use

The present disclosure provides color changing resin compositions where the resin compositions are preferably water insoluble polymers (i.e. solid beads) that are pH sensitive color indicators and have various applications of use. In particular, the compositions can be used for assessing the pH (and therefore the concentration) of a cleaning composition, in particular, sanitizing and/or disinfecting compositions. The applications of using the color changing resin compositions can provide a visual correlation in the pH and effectiveness of certain sanitizers and disinfectants. This provides an advantage over various traditional mechanisms for assessing whether a necessary pH and/or concentration of active sanitizing or disinfecting agents are present. According to various applications of use, the color changing resin compositions can be employed to visually indicate whether a pH (and in some instances the concentration of active ingredient which impacts pH) is achieved and maintained over time, which is related to the concentration of the active ingredient.

In various embodiments the use of the color changing resin compositions in a cleaning composition can overcome the inconveniences of traditional pH and/or concentration measurements. The methods do not require immersion (of a test strip) or addition (of a use solution) to a vial of test chemical for a set amount of time such as 5 seconds, required reading of the result within 10 seconds at a set temperature, and a required comparison to a standard where colors and hues must be compared within that 10 second period before the results may no longer be viable. Such methods are difficult to employ in the field due to differences in conditions such as temperature and the requirement that results be read and determined within set amounts of time. Further, such methods are irreversible and thus not continual and in real-time where changes to the compositions can be readily monitored over a time period without the need to retest.

Instead, the methods of using the color changing resin compositions eliminate the need for expensive and/or complicated equipment used to measure the active cleaning components in a composition are not necessary. Further, there is no need to analyze and interpret test results to evaluate the suitability of a particular concentration. Rather the use of color changing resin compositions in a cleaning composition can provide a real-time visual indication by a color change that a composition has a desired pH (and can be extrapolated to indicate a desired concentration) for the desired cleaning application, i.e., whether the concentration is sufficient for sanitizing or disinfecting.

There are various applications of using the color changing resin compositions, which are not intended to be limited to sanitizing applications of use, which represent one exemplary application of use. In embodiments the color changing resin compositions are employed for sanitizing (including reusable third sink sensors) and/or disinfecting applications. In an embodiment, the color changing resin compositions are combined with a cleaning, sanitizing and/or disinfecting composition in a container (e.g. sink, bucket, etc.). In other embodiments, the color changing resin compositions are used to form a container (e.g. sink, bucket, etc. that is made out of the color changing resin compositions). In embodiments, the color changing resin compositions will change color upon a predetermined pH (specific to the pH sensitive sulfonated dye employed therein). The change in color can therein indicate that a concentration (as corrected to a pH) or pH of the composition is out of specification and is in need of replacing or replenishing (i.e. time to change a solution to ensure sufficient efficacy of the cleaning, sanitizing and/or disinfecting).

An additional exemplary application of use for the color changing resin compositions includes a visual indicator of whether a composition is safe for handling without personal protective equipment (PPE). One skilled in the art will understand that use of PPE is often required for safety purposes when coming into contact with materials (e.g. cleaning compositions) with strongly alkaline or strongly acidic pH. The use of the color changing resin compositions with such materials can provide a visual indicator or reminder for the need to use PPE.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

Synthesis of a polymer resin was conducted using a two-step synthesis. The first step included a quaternization reaction with a heterocyclic amine to introduce the nitrogen-containing heterocyclic cationic group on crosslinked polystyrene resin as depicted in reaction scheme of FIG. 2. The second step included an anion exchange reaction to replace the anion of the resulting resin backbone with a pH-sensitive sulfonated dye as depicted in the reaction scheme of FIG. 3.

Backbone quaternization reaction with 1-methylimidiazole: Poly(styrene-co-vinylbenzylchloride-co-divinylbenzene) (Cl⁻ density=about 4.0 mmol/g, 100 g, 400 mmol) was charged into a 500 mL three neck flask equipped with a mechanical stirrer, and purge valve. Acetone (300 ml) was added into the flask and stirred to form a viscous slurry of polymer resin. 1-Methylimidazole (73 g, 890 mmol) was then added and stirred at 70° C. for 18 hours. After cooling, the reaction mixture was filtered using a fritted glass funnel under vacuum, washed sequentially with de-ionized water and ethanol, and finally air dried.

Anion exchange reaction: Poly [styrene-co-3-ethyl-1-(4-vinylbenzyl)-3H-imidazol-1-ium chloride-co-divinylbenzene] (25 g) was charged into a 250 mL flask containing 100 mL DI water. Aqueous solution of Congo red dye (2g in 20 mL) was gradually added into the flask under stirring which resulted in the formation of red colored slurry of resin. The slurry was gently stirred at room temperature for 3 hours to allow anion exchange. The mixture was then filtered using fritted glass funnel under vacuum and then washed repeatedly with de-ionized water until the effluent was neutral. The red colored beads were washed with ethanol and air dried.

### Example 2

Following synthesis of the sulfonated dye onto the solid supported backbone (crosslinked polystyrene resin) described in Example 1, an evaluation study was conducted to confirm ability of the resin to change colors upon change in pH conditions.

As described in Example 1, the resin beds contained methylimidazolium chloride and were further compared to those having the sulfonated dye installed. FIG. 5 shows the resin beads in the following conditions:

A. of FIG. 5 shows the resin beds at the completion of step 1 in Example 1 in DI water;

B. of FIG. 5 shows the resin beads containing methylimidazolium dye-sulfonate (where the Congo red functionalized dye is installed at the completion of step 2) in DI water; and

C. of FIG. 5 shows the resin beads containing methylimidazolium dye-sulfonate (where the Congo red functionalized dye is installed at the completion of step 2) in DI water following addition of HCl, at pH=2 or below.

The color of the resin beads changed from pinkish-red in FIG. 5B at a neutral pH to a bluish-grey in FIG. 5C at an acidic pH. The subsequent addition of NaOH to the vial of resin beads containing methylimidazolium dye-sulfonate increased pH to above 5 and the color of the resin beads changed back to the pinkish-red color. The same color changes between FIG. 5B and FIG. 5C were observed over multiple pH increase/decrease cycles.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A color changing resin composition comprising:
a resin backbone with a heterocyclic cationic group; and
a pH-sensitive dye complexed to the resin backbone,
wherein the pH sensitive dye is a sulfonated dye, carboxylate dye, or nitrated dye, and
wherein the composition is a water insoluble polymer.

2. The composition of claim 1, wherein the resin backbone is a polyalkylene, polyacrylate, polycarbonate, polyarylene, polyaryletherketone, or polyamide-imides, and wherein the nitrogen-containing heterocyclic cationic group is pyrrolium, imidazolium, pyrazolium, oxazolium, thiazolium, pyridinium, pyrimidinium, pyrazinium, pyradizimium, thiazinium, morpholinium, piperidinium, piperizinium, or pyrollizinium.

3. The composition of claim 2, wherein the polyalkylene resin backbone is a vinyl polymer.

4. The composition of claim 2, wherein the resin backbone is a polyethylene, polypropylene, polyalkylacrylates, polystyrene, polyurethane, polyvinyl chloride, polyphenol-aldehyde, polytetrafluoroethylene, polybutylene terephthalate, polycaprolactam, and/or poly(acrylonitrile butadiene styrene).

5. The composition of claim 1, wherein the resin backbone is insoluble and is crosslinked or un-crosslinked.

6. The composition of claim 1, wherein the pH-sensitive dye is an azo dye comprising one or more diazenyl functional groups with the following structure: 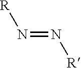
wherein R is an aryl group or an alkyl group having between 2 and 20 carbons, and wherein R′ is an aryl group or an alkyl group having between 2 and 20 carbons.

7. The composition of claim 6, wherein the azo dye is Allura red AC, azo violet, basic red 18, bromothymol blue, Congo red, direct blue 1, direct brown 103, direct brown 186, direct brown 78, direct red 79, direct black 19, m-cresol purple, methyl orange, methyl red, para red, phenol red, reactive orange 16, tartrazine, thymol blue, xylenol blue, xylenol orange, alizarin yellow, or a combination thereof.

8. The composition of claim 7, wherein the pH-sensitive dye exhibits a visual change in color at an acidic or base indicator pH range.

9. The composition of claim 1, wherein the composition is reusable.

10. The composition of claim 1, wherein the composition is in the form of beads, rods, sheets, or strips.

11-31. (canceled)

32. A method of use comprising:
visually detecting a color change in a composition comprising the color changing resin composition according to claim 1.

33. The method of claim 32, wherein the composition further comprises an alkaline composition, an acidic composition, or combinations thereof.

34. The method of claim 33, wherein the alkaline composition or the acidic composition are cleaning and/or sanitizing compositions.

35. The method of claim 32, wherein the color change indicates a change in pH outside of a predetermined range for one or more of the following: concentration of an active within a use solution, safety in contacting with or without PPE, or combinations thereof.
